(19) United States
(12) Patent Application Publication
(10) Pub. No.: US 2021/0064995 A1
(43) Pub. Date: Mar. 4, 2021

(54) METHOD, DEVICE AND COMPUTER PROGRAM FOR CREATING A PULSED NEURAL NETWORK

(71) Applicant: Robert Bosch GmbH, Stuttgart (DE)

(72) Inventors: Thomas Pfeil, Renningen (DE); Alexander Kugele, Renningen (DE)

(73) Assignees: Robert Bosch GmbH, Stuttgart (DE); Robert Bosch GmbH, Stuttgart (DE)

(21) Appl. No.: 16/937,353

(22) Filed: Jul. 23, 2020

(30) Foreign Application Priority Data
Aug. 28, 2019 (DE) 102019212907.2

(51) Int. Cl. G06N 3/08; G06N 3/04

(52) U.S. Cl. CPC G06N 3/08; G06N 3/049

(57) ABSTRACT

A method for creating a pulsed neural network (Spiking Neural Network). The method begins with an assignment of a predefinable control pattern (rollout pattern) to a deep neural network. This is followed by a training of the deep neural network using the control pattern. This is followed by a conversion of the deep neural network into the pulsed neural network, the connections of the pulsed neural network being assigned a delay, in each case as a function of the control pattern. A computer program, a device for carrying out the method, and to a machine-readable memory element are also described.

### CROSS REFERENCE

The present application claims the benefit under 35 U.S.C. § 119 of German Patent No. DE 102019212907.2 filed on Aug. 28, 2019, which is expressly incorporated herein by reference in its entirety.

### FIELD

The present invention relates to a method for creating a pulsed neural network by converting a trained artificial neural network into the pulsed neural network. The present invention also relates to a device and a computer program, each of which are configured to carry out the method.

### BACKGROUND INFORMATION

It is possible to operate artificial neural networks fully parallelized, as shown by the authors Volker Fischer, Jan Köhler and Thomas Pfeil in their publication “The streaming rollout of deep networks-towards fully model-parallel execution.” arXiv preprint arXiv: 1806.04965 (2018), and as shown in German Patent Application No. DE 20 2018 104 373 U1.

Pulsed neural networks are available (Spiking Neural Network, SNN). Pulsed neural networks are a variant of artificial neural networks (ANN) and are very similar to the biological neural networks. As in the biological neural networks, neurons of the pulsed neural network do not fire in each propagation cycle, as it is carried out in deep neural networks, but only when a diaphragm potential exceeds a threshold value. When a neuron of the pulsed neural network fires, it generates a short pulse (spike), which migrates to other neurons which, in turn, increase or reduce their diaphragm potential according to this pulse.

Pulsed neural networks are complex to train, since sequences of short pulses (spike trains) are represented by Dirac functions, which are not mathematically derivable.

It is possible to convert trained artificial neural networks into trained pulsed neural networks, as shown by the authors Rueckauer Bodo, Lungu Iulia-Alexandra, Hu Yuhuang, Pfeiffer Michael, Liu Shih-Chii in their publication “Conversion of Continuous-Valued Deep Networks to Efficient Event-Driven Networks for Image Classification” in Frontiers in Neuroscience doi 10.3389/fnins.2017.00682 (2017), https://doi.org/10.3389/fnins.2017.00682.

### SUMMARY

Pulsed neural networks are highly efficient during the inference, since layers, in particular, neurons of the pulsed neural network may be implemented completely in parallel on a dedicated hardware. In the case of a converted artificial neural network, however, it is not possible to utilize this advantage, in particular, with a bridging connection (skip-/recurrent connection) into a pulsed neural network. When an artificial neural network is converted using bridging connections, the pulsed neural network may only be sequentially executed, for example, via wait cycles, which is inefficient, however.

Artificial neural networks also differ from pulsed neural networks in that artificial neural networks do not integrate pieces of information over time, since artificial neural networks instantaneously process and subsequently forward only the respectively updated available information for each propagation cycle. This means, artificial neural networks are operated sequentially, whereas pulsed neural networks are operated in parallel.

This may mean that pieces of information in a pulsed neural network, which have been created by a conversion of an artificial neural network, are not available at the correct neuron at the correct point in time. There is also the problem that the temporal integration of the pulsed neural network is not taken into account during the training of the artificial neural network. This may reflect negatively on the accuracy of the results and reliability of the pulsed neural network.

The method provided below has the advantage over the related art that the manner in which the pulsed neural network is operated is taken into account already during the training of a deep neural network. The temporal integration of the pieces of information of the pulsed neural network may also be taken into account already during the training of the deep neural network. In this way, the subsequently carried out conversion of the deep neural network into a pulsed neural network will result in a particularly efficient pulsed neural network having a high degree of accuracy.

### SUMMARY

In a first aspect of the present invention, a, in particular, computer-implemented method for creating a pulsed neural network (Spiking Neural Network, SNN) is provided. In accordance with an example embodiment of the present invention, the method includes the following steps: assigning a predefinable control pattern (rollout pattern) to a deep neural network. The deep neural network includes a plurality of layers, each of which are connected to one another according to a predefinable sequence. The control pattern characterizes at least one sequence of, in particular, sequential, calculations, according to which the layers or neurons of the deep neural network ascertain their intermediate variables. The control pattern may also characterize multiple sequences, which may then be carried out in parallel during the operation of the deep neural network as a function of the control pattern. The control pattern further characterizes that at least one of the layers of the deep neural network ascertains its intermediate variable independently of the sequence. The neurons or the layers ascertain their intermediate variables as a function of input variables provided by them, preferably using a (non)-linear activation function. The neurons or the layers output their intermediate variables which, in turn, are available as input variables to the following neurons/layers. This is followed by a training of the deep neural network using the control pattern and, in particular, using training data. This means, during the training, the training data may be propagated by the deep neural network as a function of the control pattern. This is followed by a conversion of the deep neural network into the pulsed neural network. A temporal delay is assigned to connections or neurons of the pulsed neural network, in each case as a function of the control pattern. It may be said that the delay corresponds to a physical period of time by which the neuron of the pulsed neural network outputs the short pulse or the sequence of short pulses in a delayed manner or the connection forwards the latter in a delayed manner or a processing of the short pulse/sequence of short pulses in the target neuron takes place in a delayed manner. The temporal delay may be assigned to the connection of the pulsed neural network, which corresponds to the corresponding connection of the deep neural network, which connects the layer or the neuron of the deep neural network, which ascertain(s) the intermediate variable independently of the sequence, to a following layer/neuron. The temporal delay may be assigned to the neuron of the pulsed neural network, which corresponds to the corresponding neuron of the deep neural network, which ascertains the intermediate variable independently of the sequence.

It is possible that the pulsed neural network is subsequently stored or operated in a memory. Operating the pulsed neural network may be understood to mean that the pulsed neural network obtains an input variable, which is propagated/processed by the pulsed neural network as a function of the assigned delays, and the pulsed neural network outputs an output variable, for example, a classification, regression or the like. The delay may result in the connections of the pulsed neural network forwarding the short pulses in a time-delayed manner, alternatively, the layers/neurons of the pulsed neural networks outputting their short pulses in a delayed manner.

The sequence may define a succession, according to which the layers of the deep neural network each ascertain their intermediate variables/an output variable, for example the sequence may correspond to the succession, according to which the layers are situated in the deep neural network. According to a “classic/sequential” operation of the deep neural network, each layer ascertains its intermediate variable step-wise according to its position in the sequence and during which all other layers are inactive. If the control pattern characterizes that one of the layers ascertains its intermediate variable independently of the sequence, then this layer is active independently of its position in the sequence.

A pulsed neural network may be understood to mean an artificial neural network, in which neurons of the pulsed neural network output short pulses (spikes). An artificial neural network may be understood to mean a plurality of layers connected to one another, which are inspired by the biological neural networks.

An artificial neural network is based on a collection of connected neurons that model the neurons in a biological brain. Each connection, like the synapses in a biological brain, may transmit an intermediate variable from one artificial neuron to the other. The layers, in particular neurons, are connected to one another via connections. The connections forward the intermediate variable of the layer/of the neuron and provide the intermediate variable as an input variable to the following connected layer/neuron. The connections may each be assigned a weight, which weights the intermediate variable. An artificial neuron that obtains an intermediate variable may process the latter and then forward it via its connections to additional artificial neurons connected thereto. In deep neural networks, the intermediate variables may be a real number and the output of each artificial neuron is calculated by a (non-)linear function of the sum of its inputs. In contrast to which, a rate of short pulses is transmitted between neurons in pulsed neural networks, which may correspond essentially on average to the real number.

It has been found that the training of the deep neural network with a sequential propagation of the training data by deep neural networks is in complete contrast to the completely parallel operating mode of pulsed neural networks. In pulsed neural networks, all neurons are able to update their states simultaneously. The conversion of a deep neural network that has been sequentially trained may therefore result in a pulsed neural network, in which pieces of information are processed at wrong points in time in the course of the propagation. That advantage of the method is that with the control pattern, it may be ensured that the pieces of information would be present at the correct corresponding neuron of the pulsed neural network at the correct point in time. The adaptation of the delay of the connections of the pulsed neural network as a function of the control pattern enables a synchronization of the pieces of information during the propagation by the pulsed neural network. The method provided therefore results in a better performing pulsed neural network, since the parallel implementation of the layers/neurons is taken into account during the training of the deep neural network.

A further advantage is that with the modified training of the deep neural network (use of the control pattern), a transformation or a conversion of the deep neural network results in a pulsed neural network, which is better able to manage the temporal integration. The temporal integration is understood to mean that information collected in a neuron is maintained within a predefinable time window and may be combined with new added pieces of information within the time window. Consequently, it is also able to better utilize pieces of temporal information. This is reflected in the accuracy of ascertained output variables of the pulsed neural network.

It may be said that during the conversion of the deep neural network into the pulsed neural network, an additional neural network structurally identical to the deep neural network is created, which meets properties of a pulsed neural network. During the conversion, each neuron of the deep neural network may be replaced by a neuron of the pulsed neural network. It is preferably noted that the fire rate of the neurons of the pulsed neural network corresponds on average to the activations of the corresponding neurons of the deep neural network for a predefinable input variable. ReLu activation functions for the deep neural network are advantageous, because ReLu activation functions enable the use of robust normalization techniques, which linearly scale all weights of a layer in order to obtain sufficiently high fire rates in the pulsed neural network, in order to maintain the activity without reaching a saturation point.

It is provided that when assigning the control pattern, each connection or each layer and/or each neuron is assigned a control variable, which characterizes whether the intermediate variable of the respective following connected layers/neurons is ascertained according to the sequence or independently of the sequence. At least one of the layers is assigned the control variable, so that this layer ascertains its intermediate variable independently of the sequence. “Independently of the sequence” may be understood to mean that the calculations of the intermediate variables of the layers take place decoupled from the sequence.

It is provided that when controlling the calculations of the deep neural network as a function of the control pattern stepwise, in particular, in succession, one each of the layers ascertains its intermediate variable according to the sequence of the control pattern, in particular, at one predefinable simulation point in time each of a sequence of simulation points in time. The sequence of the simulation points in time may be adapted to, or correspond to, a pattern of physical points in time. The layers that ascertain their intermediate variables independently of the sequence each ascertain their intermediate variable, in each case at each step, in particular, at the respective predefinable simulation points in time.

In the following, it is established that all calculations are carried out according to the sequence of the control pattern within one simulating time window (rollout frame). The simulating time window thus contains all simulation points in time required to carry out the calculations according to the sequence of the control pattern. In the event that all layers ascertain their intermediate variable independently of the sequence, the simulating time window contains only one simulation point in time, at which all layers ascertain their intermediate variable, in particular, only when these layers are provided one input variable at the simulation point in time.

The delay d of a connection, in particular, of a neuron, is preferably a function of a number of simulating time windows, which are implemented beginning with the simulating time window, within which the intermediate variable of a first layer is ascertained, up to the simulating time window within which a second layer, which is connected to the first layer via this connection, ascertains its intermediate variable. The delay d may correspond to the number of simulating time windows of the temporally rolled out deep neural network according to the control pattern, which are implemented until the following layers connected via this connection have ascertained their intermediate variable.

In the following, it is established that the difference between two directly successive simulation points in time correspond to one time step. Each time step in the deep neural network preferably corresponds to a physical time interval Δt of the pulsed neural network. During this physical time interval Δt, the pulsed neural network is presented a single input variable (for example, the single frame of a video).

In the event that all layers ascertain their intermediate variable independently of the sequence, the simulating time window contains only one simulation point in time and may thus include a duration of a time step, preferably of the physical time interval Δt. A connection, which connects the two layers with d time steps distance (in the rolled out deep neural network according to the control pattern, that all layers are independent), obtains therefore the delay d Δt in the pulsed neural network.

The predefinable time window for the temporal integration may include a plurality of the time steps.

It is noted that in the pulsed neural network, also more than one delay may be assigned to the connections or neurons. Thus, the method is also applicable to networks having a temporal convolution, multiple delays capable of being used for one temporal filter for this purpose. If the connection spans, for example, three simulating time windows, a delay d of d=0, d=1 and d=2 must accordingly be selected for each area of the filter.

It is further provided that the deep neural network includes at least one bridging connection (skip-/recurrent connection). The bridging connection of the pulsed neural network is assigned the delay as a function of the rollout pattern and/or as a function of the number of bridged layers of the bridging connection.

Bridging connections in pulsed neural networks have the advantage that they significantly improve the temporal integration of the pulsed neural networks. When converting the deep neural network using bridging connections into an equivalent pulsed neural network, the problem particularly frequently occurs that the pieces of information in the deep neural network are processed at different points in time than is provided in the pulsed neural network. The introduction of the delays (d Δt) then guarantees that pieces of information from different neurons arrive along the bridging connection and the connection at the correct point in time at the correct layer/neuron in the pulsed neural network. With the control pattern, it is possible to already take this into account during the training. This approach further enables control patterns to be flexibly used, for example, as a function of the available computing resources during the training, in order to nevertheless be able to take the temporal integration during the training sufficiently into account.

An additional bridging connection may be added to the deep level neural network. The advantage is that the temporal integration becomes even more exact as a result.

The bridging connection may be a forward or backward directed bridging connection (skip connection) or a connection which connects an input and an output of an identical layer (recurrent connection). The advantage of bridging connections is that they enlarge a receptive field of the pulsed neural networks over time.

In accordance with an example embodiment of the present invention, it is further provided that a spatio-temporal receptive field is used. It is provided that the spatio-temporal receptive field goes back at least one simulation time window, in order to enable temporal integration. The spatio-temporal receptive field may be established by the control pattern. While taking the respective application of the pulsed neural network into account, the temporal receptive field should be selected in such a way that temporal sequences may be dissolved.

In accordance with an example embodiment of the present invention, it is further provided that parameters and/or intermediate variables of the deep neural network are quantized during the training. In addition to the advantage that the training may be carried out more rapidly and efficiently, the quantization also has the unexpected advantage that the quantization has a positive impact on the conversion of the deep neural network into the pulsed neural network. In order to resolve small differences in the activations, a number of simulation steps per simulation time window must be set to high values which, in turn, results in higher fire rates and in lower energy efficiency. In order to reduce the required simulation steps per time step, this inherent limitation of lower dissolutions at low fire rates is integrated via the quantization of activations during the training. Simulations have further shown that the fire rates converge more rapidly to the target fire rates of the pulsed neural network as a result of the quantization of the deep neural network, since the quantization highlights a plurality of particular activations.

A quantization may be understood to mean that a predefinable number of bits is used in order to represent the parameters. The parameters (such as, for example, weights or threshold values) are preferably quantized with less than 32 bits or 16 bits, 8 bits or 4 bits. A linear quantization is preferably used during the training. During the training, the quantization resolution may be a function of a maximum activation Aₘₐₓ. The maximum activation Aₘₐₓ may be an exponential moving average) over a standard deviation of the positive activations during the forward propagation of the training. It is possible that each layer/neuron n has its own maximum activation Aₘₐₓⁿ.

In accordance with an example embodiment of the present invention, it is further provided that the control pattern corresponds to a streaming control pattern (streaming rollout). The streaming control pattern is understood to mean that all layers/neurons of the deep neural network are operated independently of the sequence and the layers/neurons ascertain their intermediate variable at each simulation point in time, in each case as a function of one input variable. The streaming control pattern is advantageous since the training becomes more computing- and memory-efficient. The layers of the deep neural network are always active, since they are operated in parallel, which results in a higher execution speed and higher responsiveness of the deep neural network. This type of operation of the deep neural network corresponds essentially to the type of operation of the pulsed neural network, since then the fire rates essentially correspond to the activations of the deep neural network. With this approach, it is therefore possible to generate the pulsed neural network with a minimum of effort, among other things, also because the delays may then be set uniformly equal to 1 Δt.

In accordance with an example embodiment of the present invention, it is further provided that a spatial signal dropout (spatial dropout) is used during the training. During the spatial signal dropout, complete filters are temporarily deactivated. For example, an image at the input may have the dimension 3, 30, 40, color, y, x and may be processed with a convolutional layer including 6 kernels/channels. The dimension of the output is then 6, 30, 40. During the spatial signal dropout, at least one of the 6 kernels would be deactivated so that no information may be transmitted over this path. The neural network learns as a result that different channels process independent pieces of information. This property is maintained during the conversion into a pulsed neural network. The advantage in this case is that this approach means that fewer neurons fire, as a result of which the energy efficiency is increased.

In accordance with an example embodiment of the present invention, it is further provided that after the conversion, the pulsed neural network is operated, in particular, as a function of the delays, and the input variables of the pulsed neural network are a sequence or a time series of event-based recordings, in particular, of an event-based camera. Alternatively, the input variable may be a video sequence. Sensor values detected otherwise by a sensor are also possible.

The combination made up of the pulsed neural network, characterized by its particularly energy-efficient inference and its rapid processing, with the event-based camera, which is also able to particularly efficiently and rapidly record images, results in a particularly rapid and energy-efficient system. This system may be used anywhere, preferably in situations with scarce energy sources and/or in situations in which rapid decisions or classifications must be present. For example, the rapid implementation of the network is advantageous when identifying hazards and/or when localizing rapid objects. The pulsed neural network preferably includes two channels, one with all “on” events and one with all “off” events of the event-base camera, in order to have a greater quantity of information present at the input of the pulsed neural network.

In accordance with an example embodiment of the present invention, it is further provided that during the operation of the pulsed neural network, weights of the connections of the pulsed neural network are scaled along time, in particular, so that short pulses arriving early within a time step Δt more rapidly produce a short pulse to be emitted. The value of the weight is preferably reduced along the time step Δt. In this way, the pulsed neural network is able to ascertain its output variable in a particularly rapid, energy-efficient and reliable manner.

In accordance with an example embodiment of the present invention, it is further provided that a control variable for controlling an actuator of a technical system is ascertained or provided as a function of the ascertained output variable of the pulsed neural network. The technical system may, for example, be an at least semi-autonomous machine, an at least semi-autonomous vehicle, a robot, a tool, a work machine or a flying object, such as a drone.

In a further aspect of the present invention, a computer program is provided. The computer program is configured to carry out one of the aforementioned methods. The computer program includes instructions, which prompt a computer to carry out one of these methods including all its steps when the computer program runs on the computer. A machine-readable memory module is also provided, on which the computer program is stored. In addition, a device is provided, which is configured to carry out one of the methods.

Exemplary embodiments of the aforementioned aspects are depicted in the figures and described in greater detail below.

### BRIEF DESCRIPTION OF THE DRAWINGS

FIG. 1 schematically shows a representation of a flow chart of a method for creating a pulsed neural network in accordance with an example embodiment of the present invention.

FIG. 2 schematically shows a representation of one specific embodiment of a device for creating the pulsed neural network in accordance with an example embodiment of the present invention.

### DETAILED DESCRIPTION OF EXAMPLE EMBODIMENTS

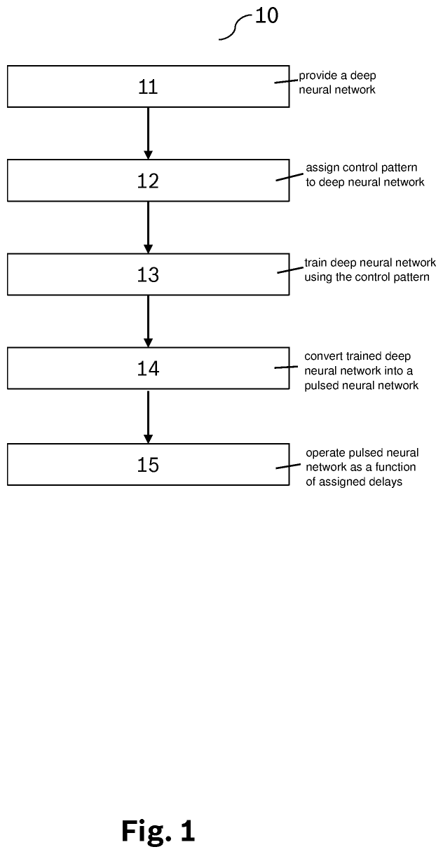

FIG. 1 schematically shows a representation of a method (10) for creating a pulsed neural network (SSN).

The method begins with step 11. In this step, a deep neural network is provided. This deep neural network includes a plurality of layers, each of which is connected to one another. The layers may each include a plurality of neurons. The deep neural network may be an already trained deep neural network or a deep neural network, in which the parameters are randomly initialized, for example.

In subsequent step 12, the deep neural network is assigned a control pattern. The control pattern characterizes in which sequence the layers ascertain their intermediate variables. For example, the control pattern may characterize that the layers calculate their output variables sequentially one after the other. In this case, each layer must wait until it is provided the respective input variable, so that this layer is then able to ascertain its intermediate variable. For example, the control pattern may also characterize that the layers are executed completely in parallel (cf. streaming rollout).

Once step 12 has been concluded and then if the provided deep neural network is not trained after step 11, step 13 follows. This step is then skipped if the neural network has already been trained. In step 13, the deep neural network is trained using the control pattern. In this case, training takes place using training data, which includes training input variables and respectively assigned training output variables, in such a way that the deep neural network ascertains as a function of the training input variables their respectively assigned training output variables. In the process, the parameters of the deep neural network may be adapted with the aid of a gradient descent method, so that the deep neural network ascertains the respectively assigned training output variables. The gradient descent method may optimize a “categorical cross entropy” cost function as a function of the parameters of the deep neural network. The input variable, for example, an image, is preferably applied multiple times in succession during the training to the deep neural network, and the deep neural network ascertains multiple times one output variable each to this input variable based on the control pattern. Alternatively, a sequence of input variables may also be used.

Once step 13 or step 12 has been concluded, step 14 follows. In this step, the trained deep neural network is converted into a pulsed neural network. During the conversion, the architecture and the parameterization of the deep neural network are used in order to create the pulsed neural network. The activations of the neurons of the deep neural network may be translated into proportional fire rates of the neurons of the pulsed neural network. For a detailed explanation regarding the behavior of the conversion, reference is made to the document “Conversion of Continuous-Valued Deep Networks to Efficient Event-Driven Networks for Image Classification” cited at the outset. In addition, the connections of the pulsed neural network are each assigned a delay as a function of the control pattern of the deep neural network used. An argmax-output layer of the pulsed neural network is preferably used, which counts all arriving pulses over a predefinable time interval t_{readout} and applies the mathematical operator argmax across the counted pulses of the neurons of the argmax output layer.

Optional step 15 may then be carried out, in which the pulsed neural network is operated as a function of the assigned delays.

The pulsed neural network may be used, for example, for an at least semi-autonomous robot. The at least semi-autonomous robot may be an at least semi-autonomous vehicle, for example. In a further exemplary embodiment, the at least semi-autonomous robot may be a service robot, an assembly robot or stationary production robot, alternatively, an autonomous flying object, such as a drone.

In one preferred specific embodiment, the at least semi-autonomous vehicle includes an event-based camera. This camera is connected to the pulsed neural network, which ascertains at least one output variable as a function of provided camera images. The output variable may be forwarded to a control unit.

The control unit controls an actuator as a function of the output variable, preferably, it controls this actuator in such a way that vehicle 10 carries out a collision-free maneuver. In the first exemplary embodiment, the actuator may be a motor or a braking system of the vehicle. In a further exemplary embodiment, the semi-autonomous robot may be a tool, a work machine or a production robot. A material of a workpiece may be classified with the aid of the pulsed neural network. The actuator in this case may be a motor that drives a grinding head.

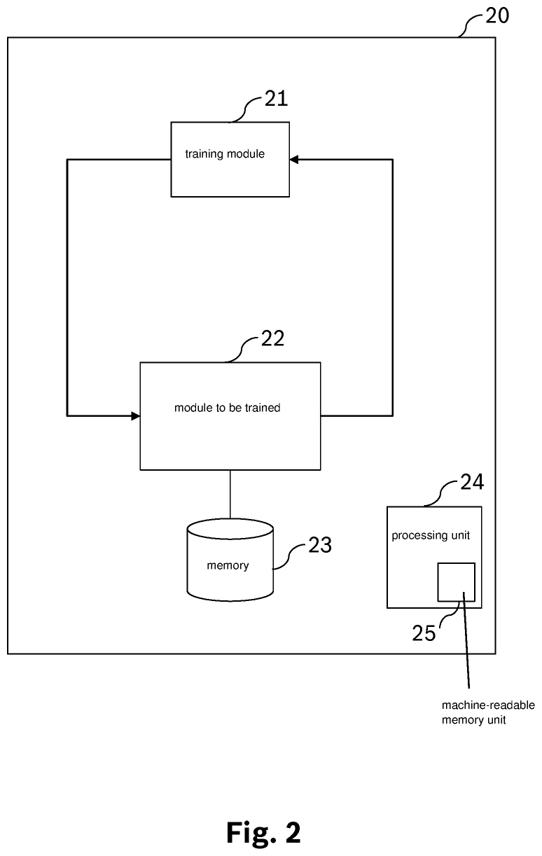

FIG. 2 schematically shows a representation of a device 20 for training the deep neural network, in particular, for carrying out the steps for training. Device 20 includes a training module 21 and a module 22 to be trained. This module 22 to be trained contains the deep neural network. Device 20 trains the deep neural network as a function of output variables of the deep neural network and, preferably using predefinable training data. The training data expediently include a plurality of detected images, or sound sequences, text excerpts, event-based signals, radar signals, LIDAR signals or ultrasonic signals, each of which are labeled. During the training, parameters of the deep neural network stored in a memory 23 are adapted.

The device further includes a processing unit 24 and a machine-readable memory element 25. A computer program may be stored on memory element 25, which includes commands which, when the commands are executed on processing unit 24, result in processing unit 24 carrying out the method for creating the pulsed neural network as shown, for example, in FIG. 1.

What is claimed is:

1. A method for creating a pulsed neural network (Spiking Neural Network) by converting a deep neural network into a pulsed neural network, comprising the following steps:
assigning a predefinable control pattern to the deep neural network, the control pattern characterizing a sequence of calculations, according to which layers or neurons of the deep neural network ascertain their intermediate variables, and the control pattern characterizing which of the layers or of the neurons of the deep neural network ascertain their intermediate variable independently of the sequence;
training the deep neural network using the control pattern; and
converting the deep neural network into the pulsed neural network, delays assigned to connections of the pulse neural network and/or to neurons of the pulsed neural network being selected as a function of the control pattern.

2. The method as recited in claim 1, wherein the deep neural network includes at least one bridging connection, wherein during conversion of the deep neural network into the pulsed neural network, the assigned delay of the bridging connection of the pulsed neural network is selected by the bridging connection as a function of the control pattern and/or as a function of a number of layers of the deep neural network bridged by the bridging connection.

3. The method as recited in claim 1, wherein during the training, parameters and/or intermediate variables of the deep neural network are quantized.

4. The method as recited in claim 1, wherein the control pattern corresponds to a streaming control pattern.

5. The method as recited in claim 1, wherein a spatial signal dropout is used during the training.

6. The method as recited in claim 1, wherein training input variables of the deep neural network are each arranged multiple times in succession to form a sequence of identical input variables or the training input variables are sequences of temporally successive input variables, and wherein the deep neural network is trained based on the sequences.

7. The method as recited in claim 1, wherein after the conversion, the pulsed neural network is operated as a function of the delays, and during the operation of the pulsed neural network, weights of the connections of the pulsed neural network are scaled within time steps, during which an input variable is present at the input of the pulsed neural network.

8. The method as recited in claim 7, wherein during the operation of the pulsed neural network, input variables of the pulsed neural network are sequences or time series of event-based recordings of an event-based camera.

9. A non-transitory machine-readable memory element on which is stored a computer program for creating a pulsed neural network (Spiking Neural Network) by converting a deep neural network into a pulsed neural network, the computer program, when executed by a computer, causing the computer to perform the following steps:
assigning a predefinable control pattern to the deep neural network, the control pattern characterizing a sequence of calculations, according to which layers or neurons of the deep neural network ascertain their intermediate variables, and the control pattern characterizing which of the layers or of the neurons of the deep neural network ascertain their intermediate variable independently of the sequence;
training the deep neural network using the control pattern; and
converting the deep neural network into the pulsed neural network, delays assigned to connections of the pulse neural network and/or to neurons of the pulsed neural network being selected as a function of the control pattern.

10. A device configured to create a pulsed neural network (Spiking Neural Network) by converting a deep neural network into a pulsed neural network, the device configured to:
assign a predefinable control pattern to the deep neural network, the control pattern characterizing a sequence of calculations, according to which layers or neurons of the deep neural network ascertain their intermediate variables, and the control pattern characterizing which of the layers or of the neurons of the deep neural network ascertain their intermediate variable independently of the sequence;
train the deep neural network using the control pattern; and
convert the deep neural network into the pulsed neural network, delays assigned to connections of the pulse neural network and/or to neurons of the pulsed neural network being selected as a function of the control pattern.

11. A non-transitory computer readable medium on which is stored a pulsed neural network, the pulsed neural network being formed by performing, by a computer, the following steps:
assigning a predefinable control pattern to a deep neural network, the control pattern characterizing a sequence of calculations, according to which layers or neurons of the deep neural network ascertain their intermediate variables, and the control pattern characterizing which of the layers or of the neurons of the deep neural network ascertain their intermediate variable independently of the sequence;
training the deep neural network using the control pattern; and
converting the deep neural network into the pulsed neural network, delays assigned to connections of the pulse neural network and/or to neurons of the pulsed neural network being selected as a function of the control pattern.
